(19) United States
(12) Patent Application Publication
(10) Pub. No.: US 2014/0369077 A1
(43) Pub. Date: Dec. 18, 2014

(54) PFC CIRCUIT FOR CHARGING CONVERTER

(71) Applicant: Hyundai Motor Company, Seoul (KR)

(72) Inventors: Ho Tae CHUN, Daejeon (KR); Seung Hyun HAN, Yongin-si (KR); Jeong Yun LEE, Hwaseong-si (KR); Chang Han JUN, Uijeongbu-si (KR); Jong Pil KIM, Gwacheon-si (KR)

(73) Assignee: HYUNDAI MOTOR COMPANY, Seoul (KR)

(21) Appl. No.: 14/046,855

(22) Filed: Oct. 4, 2013

(30) Foreign Application Priority Data
Jun. 13, 2013 (KR) 10-2013-0067692

(51) Int. Cl. H02M 7/04; H02M 3/24

(52) U.S. Cl. CPC H02M 7/04; H02M 3/24
USPC 363/17; 363/124

(57) ABSTRACT

A power factor correction (PFC) circuit for a charging converter, includes an input terminal connected with an alternating-current source, and an output terminal connected with a converter. The output terminal is connected to an electrolytic capacitor, such that the PFC circuit is connected in parallel with the converter through the electrolytic capacitor. The front end of the electrolytic capacitor is connected to an LC filter.

### CROSS REFERENCE TO RELATED APPLICATION

This application claims benefit of priority to Korean Patent Application No. 10-2013-0067692, filed on Jun. 13, 2013, the entire contents of which are incorporated herein by reference.

### TECHNICAL FIELD

The present inventive concept relates to a power factor correction (PFC) circuit for a charging converter, which can easily provide the design margin of a converter connected to an output terminal of the PFC circuit because the output terminal thereof is topologically provided with a filter.

### BACKGROUND

An on-board charger or AC-DC high-voltage battery charging converter (hereinafter, referred to as an “OBC”) is an essential part in relation to the development of plug-in hybrid and electric cars, the demand for which has lately been increasing rapidly. An OBC is provided with a PFC boost converter for the purpose of power factor improvement. It is required that the output terminal of the PFC circuit be provided with a high-capacity output power capacitor for the purpose of securing current ripple absorption and instant blackout hold-up time.

Since the output capacitor of the PFC circuit requires high rated voltage and high capacity, size reduction must be sufficiently considered at the time of design. Generally, in order to secure high capacity at a minimum capacitor size, an electrolytic capacitor is used as the output capacitor of the PFC circuit. However, the biggest disadvantage of the electrolytic capacitor may be its short life cycle. Moreover, since an output capacitor of the PFC circuit requires high rated voltage and high capacity, an electrolytic capacitor, which is most advantageous in terms of package design, is used as the output capacitor thereof. Even the smallest size of electrolytic capacitor can exhibit high rated voltage and high capacity, but it has difficulty in securing a life cycle. The reason why the life cycle of the electrolytic capacitor is short is that a material used as a dielectric is liquid. That is, when the electrolytic capacitor is exposed to a large amount of ripple current, an electrolyte is volatilized, and thus the electrolyte cannot function as a dielectric, thereby reducing the capacity of the electrolytic capacitor. For this reason, the life cycle of the electrolytic capacitor is reduced, and an excessive design margin is set.

Further, when the current/voltage ripple of the output terminal of the PFC circuit increases, it is difficult to secure a design margin at the time of designing a converter located next to the PFC circuit.

It is to be understood that the foregoing description is provided to merely aid the understanding of the present inventive concept, and does not mean that the present inventive concept falls under the purview of the related art which was already known to those skilled in the art.

### SUMMARY

Accordingly, the present inventive concept has been devised to solve problems including the above-mentioned problems, and an object of the present inventive concept is to provide a PFC circuit for a charging converter, which can easily provide a design margin of a converter located next to an output terminal of a PFC circuit because the output terminal thereof is topologically provided with a filter.

An aspect of the present inventive concept relates to a PFC circuit for a charging converter, including an input terminal connected with an alternating-current source, and an output terminal connected with a converter. The output terminal is connected to an electrolytic capacitor such that the PFC circuit is connected in parallel with the converter through the electrolytic capacitor. The front end of the electrolytic capacitor is connected to an LC filter.

The LC filter may include an electroless capacitor as a filtering capacitor.

The output terminal may be connected to a filtering capacitor of the LC filter. The filtering capacitor may be connected in parallel with a filtering inductor and the electrolytic capacitor. The electrolytic capacitor may be connected in parallel with the converter.

The LC filter may be configured to absorb ripple current having the same frequency as a frequency of the electrolytic capacitor.

Another aspect of the present inventive concept encompasses a charging converter. The charging converter also includes an alternating-current source, a converter, an electrolytic capacitor and an LC filter. The charging converter also includes a PFC circuit including an input terminal connected with the alternating-current source, and an output terminal connected with the converter. The output terminal is connected to the electrolytic capacitor such that the PFC circuit is connected in parallel with the converter through the electrolytic capacitor. The front end of the electrolytic capacitor is connected to the LC filter.

The LC filter of the charging converter may include an electroless capacitor as a filtering capacitor.

The output terminal of the PFC circuit of the charging converter may be connected to a filtering capacitor of the LC filter. The filtering capacitor may be connected in parallel with a filtering inductor and the electrolytic capacitor. The electrolytic capacitor may be connected in parallel with the converter.

The LC filter of the charging converter may be configured to absorb ripple current having the same frequency as a frequency of the electrolytic capacitor.

According to the present inventive concept, in relation to the output terminal of the PFC circuit, a low-capacity LC filter may be connected to the output terminal thereof prior to being connected to an electrolytic capacitor to share electrical stress applied to the electrolytic capacitor, thus increasing design freedom as well as securing a life cycle.

Further, according to the present inventive concept, the output ripple of the PFC circuit may be reduced, thus having an advantage in designing a converter located next to the PFC circuit.

### BRIEF DESCRIPTION OF THE DRAWINGS

The foregoing and other features of the inventive concept will be apparent from a more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept.

FIG. 1 is a view showing a PFC circuit for a charging converter according to an embodiment of the present inventive concept.

### REFERENCE NUMERALS

100: alternating-current source
200: PFC circuit
300: converter
400: LC filter
500: electrolytic capacitor

### DETAILED DESCRIPTION

Examples of the present inventive concept will be described below in more detail with reference to the accompanying drawings. The examples of the present inventive concept may, however, be embodied in different forms and should not be construed as limited to the examples set forth herein. Like reference numerals may refer to like elements throughout the specification.

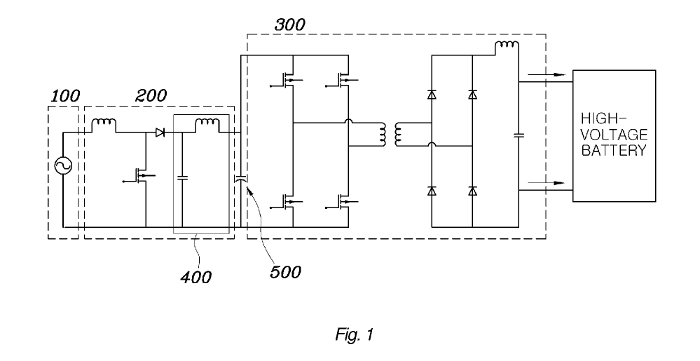

FIG. 1 is a view showing a PFC circuit for a charging converter according to an embodiment of the present inventive concept.

The configuration shown in FIG. 1 may be applied to a high-voltage battery charging system used in environment-friendly cars (plug-in hybrid/electric/fuel cell cars). FIG. 1 shows an exemplary interposition of an LC filter 400, according to an embodiment of the present inventive concept. The LC filter 400 may include a low-capacity electroless capacitor and an inductor, and may function to reduce the electrical stress of a high-capacity capacitor.

When a converter 300 topologically operates, it is possible to reduce the output ripple component of a PFC circuit 200 at a system level at the time of interposing the LC filter 400. A plug-in hybrid and electric car may need an on-board charger (OBC) for charging a high-voltage battery. The OBC may need a PFC boost circuit for power factor improvement, and the output terminal of the PFC circuit may need a high-capacity/high-voltage capacitor in order to secure instant blackout hold-up time and reduce current/voltage ripple.

An electrolytic capacitor 500 may be provided at an output terminal of the PFC circuit 200 in consideration of package design. In this case, there is a disadvantage in securing a life cycle. An electrolytic capacitor uses a liquid. Therefore, when excessive electrical stress (current ripple) is applied to the electrolytic capacitor, an electrolyte may be volatilized, thus shortening the life cycle of the electrolytic capacitor.

Further, when current/voltage ripple components are not sufficiently restricted at the output terminal of the PFC circuit 200, it is difficult to secure a design margin in the design of a subsequent converter.

When the electrolytic capacitor 500 provided at the output terminal of the PFC circuit 200 is exposed to excessive electrical stress, its capacity may be rapidly decreased, thus remarkably reducing its life cycle. This means that it is difficult to satisfy a term of guarantee at the level of a vehicle as well as at the level of an OBC. Further, when an excessive design margin is set in order to secure a life cycle, the increase in package size and weight of the electrolytic capacitor 500 may be inevitable, thereby acting as a minus factor in efficiency/mileage in terms of a vehicle system.

Additionally, when the current/voltage ripple of the output terminal of the PFC circuit 200 increases at a system level, it may be difficult to secure the design margin of a converter located behind the PFC circuit 200, and there may be disadvantages to the performance (efficiency, package size, etc.) of the OBC.

A conventional PFC circuit is configured such that its output terminal is independently provided with a high-capacity electrolytic capacitor to secure hold-up time and restrict output ripple. In this case, the electrolytic capacity independently absorbs current ripple, and thus the life cycle thereof decreases. In order to secure a life cycle, the design margin of a PFC capacitor can be increased, but the increase in design margin thereof has a negative influence on a package configuration.

A conventional PFC circuit is also configured such that its electrolytic capacitor operates to independently reduce ripple components. Thus, there is a limitation in reducing the entire output ripple of a PFC circuit at a system level without a sufficient design margin.

Therefore, the PFC circuit 200 for a charging converter according to an embodiment of the present inventive concept may be configured such that an alternating-current source 100 is connected to an input terminal of the PFC circuit 200 and a converter 300 is connected to an output terminal of the PFC circuit 200. Here, an electrolytic capacitor 500 may be provided at the output terminal of the PFC circuit 200. The PFC circuit 200 may be connected in parallel with the converter 300 by the electrolytic capacitor 500. The LC filter 400 may be provided at the front end of the electrolytic capacitor 500. Further, the LC filter 400 may use an electroless capacitor. As the electroless capacitor, an electroless capacitor (ceramic, film or the like) having relatively large allowable ripple current may be selected.

Meanwhile, as shown in FIG. 1, a filtering capacitor constituting the LC filter 400 may be provided at the output terminal of the PFC circuit 200. A filtering inductor and an electroless capacitor 500 may be connected in parallel with the filtering capacitor. A converter may be connected in parallel with the electroless capacitor 500.

Further, the LC filter 400 may absorb a ripple current having the same frequency as that of the electrolytic capacitor 500.

Specifically, in the design and manufacture of a PFC circuit for a charging converter according to an embodiment of the present inventive concept, the design specification thereof may be satisfied by selecting element values in the following order.

1. The voltage range, output power and maximum allowable load of a high-voltage battery may be selected.

2. The maximum value of AC voltage used may be selected.

3. The maximum power of a power factor correction (PFC) circuit may be selected such that it is equal to the maximum value of AC voltage used.

4. The capacity of an electrolytic capacitor provided at the output terminal of the PFC circuit may be selected in consideration of the hold-up time, at which an AC-used power source is not intermittently supplied, and the ripple amount of output voltage of the PFC circuit.

5. The low frequency component and high frequency component of allowable ripple current of an electrolytic capacitor may be respectively calculated and totaled.

6. The element value of an LC filter may be selected such that the LC filter absorbs the same frequency as that of a ripple component absorbed by the electrolytic capacitor. The LC filter may be designed such that it shares ripple current with the electrolytic capacitor. The LC filter may be designed in considering that when LC resonance occurs, energy cannot be supplied to a converter, and the output ripple of a PFC circuit can be increased. As a capacitor for the LC filter, an electroless capacitor (ceramic, film or the like) having relatively large allowable ripple current may be selected.

According to an embodiment of the present inventive concept, the output terminal of the PFC circuit may be provided with a low-capacity electroless capacitor (ceramic, film, etc.), an inductor and a high-capacity electrolytic capacitor to secure the life cycle of the electroless capacity and minimize the output ripple of the PFC circuit. The electroless capacitor having large allowable current ripple may be used as an auxiliary capacitor of the high-capacity electrolytic capacitor to improve electrical performance and optimize the package design of a system level. Consequently, this electrical/mechanical performance improvement may lead to the improvement of guarantee term/fuel efficiency at a vehicle level.

A conventional PFC circuit is configured such that an electrolytic capacitor is independently provided at the output terminal thereof and thus a design margin is greatly set for the purpose of securing a life cycle. For this reason, the increase in size of the electrolytic capacitor is inevitable. However, according to an embodiment of the present inventive concept, a low-capacity electroless capacitor may be used together with a high-capacity electrolytic capacitor, thus optimizing the design margin of the high-capacity electrolytic capacitor and improving the weight and size thereof.

As described above, in a PFC circuit for a charging converter according to an embodiment of the present inventive concept, an additional LC filter may share the ripple current load of an electrolytic capacitor, thus securing the life cycle of the electrolytic capacitor and optimizing the packaging.

Further, in a PFC circuit for a charging converter according to an embodiment of the present inventive concept, an additional LC filter and an electrolytic capacity may absorb ripple components at the same time, thus may be advantageous in restricting the output ripple of the PFC circuit at a system level.

Although embodiments of the present inventive concept have been disclosed for illustrative purposes, those skilled in the art will appreciate that various modifications, additions and substitutions are possible, without departing from the scope and spirit of the inventive concept as disclosed in the accompanying claims.

What is claimed is:

1. A power factor correction (PFC) circuit for a charging converter, comprising:
an input terminal connected with an alternating-current source; and
an output terminal connected with a converter, wherein:
the output terminal is connected to an electrolytic capacitor such that the PFC circuit is connected in parallel with the converter through the electrolytic capacitor, and
a front end of the electrolytic capacitor is connected to an LC filter.

2. The PFC circuit of claim 1, wherein the LC filter includes an electroless capacitor as a filtering capacitor.

3. The PFC circuit of claim 1, wherein:
the output terminal is connected to a filtering capacitor of the LC filter,
the filtering capacitor is connected in parallel with a filtering inductor and the electrolytic capacitor, and
the electrolytic capacitor is connected in parallel with the converter.

4. The PFC circuit of claim 1, wherein the LC filter is configured to absorb ripple current having the same frequency as a frequency of the electrolytic capacitor.

5. A charging converter, comprising:
an alternating-current source;
a converter;
an electrolytic capacitor;
an LC filter; and
a power factor correction (PFC) circuit, including an input terminal connected with the alternating-current source, and an output terminal connected with the converter, wherein:
the output terminal is connected to the electrolytic capacitor such that the PFC circuit is connected in parallel with the converter through the electrolytic capacitor, and
a front end of the electrolytic capacitor is connected to the LC filter.

6. The charging converter of claim 5, wherein the LC filter includes an electroless capacitor as a filtering capacitor.

7. The charging converter of claim 5, wherein:
the output terminal is connected to a filtering capacitor of the LC filter,
the filtering capacitor is connected in parallel with a filtering inductor and the electrolytic capacitor, and
the electrolytic capacitor is connected in parallel with the converter.

8. The charging converter of claim 5, wherein the LC filter is configured to absorb ripple current having the same frequency as a frequency of the electrolytic capacitor.
